(19) United States
(12) Patent Application Publication
(10) Pub. No.: US 2007/0253621 A1
(43) Pub. Date: Nov. 1, 2007

(54) Method and system to process a data string

(76) Inventors: Giacomo Balestriere, Putney (AU); Gilbert Rouse Woodman, San Jose, CA (US); Andrew George Harvey, Pleasanton, CA (US)

Correspondence Address: SCHWEGMAN, LUNDBERG & WOESSNER, P.A., P.O. BOX 2938, MINNEAPOLIS, MN, 55402, US

(21) Appl. No.: 11/416,404

(22) Filed: May 1, 2006

(51) Int. Cl. G06K 9/00

(52) U.S. Cl. 382/187

(57) ABSTRACT

A method and system is described to process a data string (e.g., an XML data string). The method comprises accessing the data string to identify a plurality of data segments and a plurality of predefined reference character sequences. Each predefined reference character sequence may be located between adjacent data segments. The method further comprises creating a data structure to identify a location and length of each data segment within the data string, and a location of each predefined reference character sequences within the data string. A method and system to provide an output data string for transmission to a destination device is also described. The method comprises accessing a data structure to identify a sequence of data segments and a plurality of predefined reference character sequences. The data segments and the predefined reference character sequences are then combined based on the data structure to provide the output data string.

### FIELD

The present application is related to processing data strings.

### BACKGROUND

In a number of network applications, a data buffer may need to be sent to multiple network destinations using, for example, XML encapsulation. The data buffer may already be XML formatted or may be a raw string. When converting a data string to XML, certain control characters may need to be escaped. For example, the character “>” may need to be escaped into the string “&gt;”. If the original buffer is a contiguous array, then to escape the string may mean growing the original buffer and copying the string after the escaped character, or worse, copying the entire string and doing the substitutions into a new buffer. To properly deal with multiple escaped characters, the original string may need to be traversed in its entirety, with a new buffer size being calculated to enable the string to be copied into the buffer. In other words, currently there may be a lot of copying and manipulation of data involved with XML escaping.

In addition to minimizing data copies, a further consideration is to enable the original data string to be formatted so that the data string is suitable for use by a destination device or application.

### BRIEF DESCRIPTION OF THE DRAWINGS

FIG. 1 shows a flow chart of a method, according to an example embodiment, to process a data string to generate a data structure;

FIG. 2 shows an example data string and an example data structure generated from the data string, according to an example embodiment;

FIG. 3 shows a schematic diagram of a device, according to an example embodiment, to process a data string;

FIG. 4 shows a flow of a method, according to an example embodiment, to generate and output data string based on a data structure;

FIG. 5 shows example dictionaries, in accordance with an example embodiment, that map predefined reference character sequences and token identifiers;

FIGS. 6 and 7 shows example output strings generated using an example data structure, in accordance with an example embodiment; and

FIG. 8 shows a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of embodiments of the present invention. It will be evident, however, to one skilled in the art that the present invention may be practiced without these specific details. In an example embodiment, a method and a system is described to generate or build a data structure or map from a given data string. For example, an input XML data string may be processed (e.g., parsed) to identify predefined reference character sequences. Each reference character sequence be comprise one or more characters (e.g., alphanumeric characters). The data structure, using a plurality of pointer and length pairs, may identify context blocks (also referred to herein as data segments) and associated predefined reference character sequences interspersed between the context blocks. As described in more detail below, the data structure may subsequently be used to generate an output sequence or data string that includes substituted reference character sequences so that the output data string is suitable for communication to a destination or recipient device (e.g., a recipient network device). In an example embodiment, a reference character dictionary is utilized to identify predetermined reference character sequence for inclusion in the output data string. Although example embodiments are described merely by way of example using reference character sequence such as “<”, “&lt;” and other XML specific characters, it is important to note that the predefined reference character sequence may include any alphanumeric characters. For example, the predefined reference character sequence may be written natural language phrases or any other sequence of characters (or any token(s)) provided in a data sequence or block.

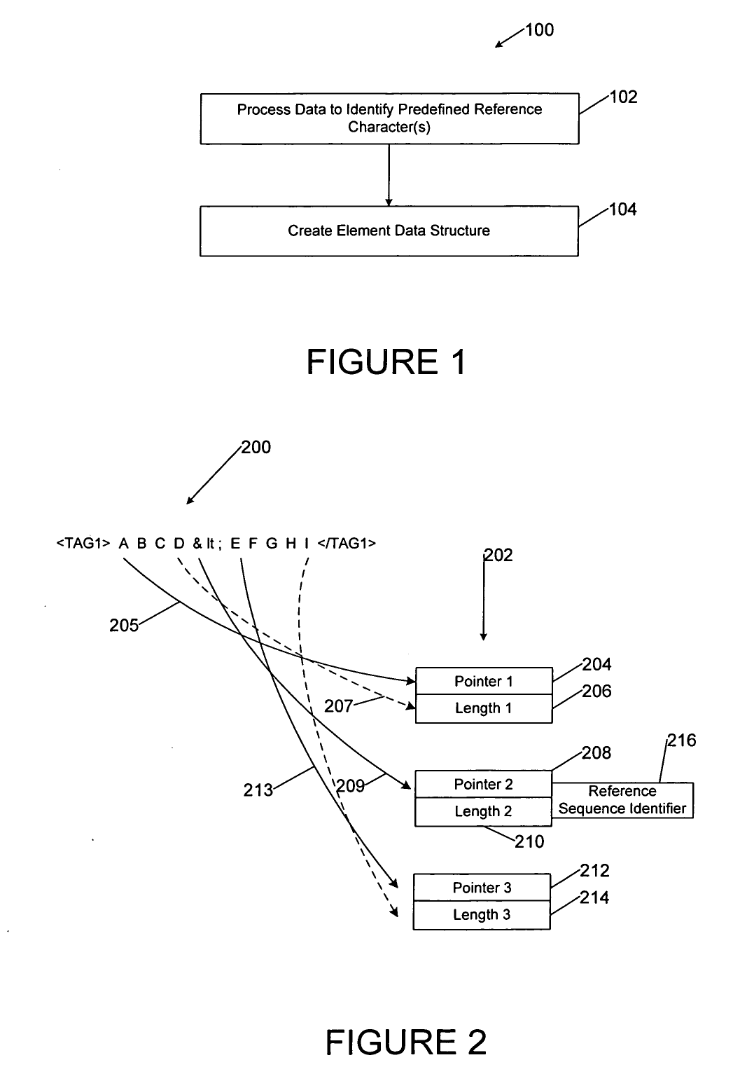

Referring to FIG. 1, a method 100, in accordance with an example embodiment, to process a contiguous data string is shown. The method 100 may be used to generate a data structure (e.g., a data structure) as described in more detail below. The data string is shown, by way of example to comprise an XML data string including a plurality of data segments. The segments of data are shown to comprise data segments of real data (context data) and predefined reference character sequences are provided between adjacent data segments. In order to generate the data structure, the method 100 in an example embodiment processes the data string (e.g., parses the data string) to identify one or more predefined reference character sequence, as indicated by block 102. For example, the reference characters may comprise XML control or reference character sequence and define a substitution boundary, which will be described in more detail below. As mentioned above, the predefined reference character sequence may be any single character or sequence of characters (e.g., alphanumeric or otherwise) that may, for example, be defined in a reference character dictionary.

After the input data string has been processed (see block 102), the method 100 may then, in an iterative manner, create or generate the data structure, as indicated by block 104. The data structure may identify the location and length of each data segment within the data string as well as the locations of the character sequences. In an example embodiment, a reference sequence identifier or a token identifier (tokenId) corresponding to each reference character sequence is stored in the data structure. However, it should be noted that the data structure may include the actual identified reference character sequence and not merely identifiers.

The method 100 will now by way of example be described in more detail with reference to FIG. 2, in which an example XML data string 200 is processed. As mentioned above, it is important to note that the method 100 is not restricted to processing XML data strings. Further, an input data string may be stored locally, be received in the real-time, or obtained in any other manner. For example, the data string 200 may be received (e.g., by a network device such as a switch or router) and then stored in a data buffer or it may be selectively retrieved from a memory component. In either event, a data structure 202 may comprise a plurality of pointer and length pairs 204 and 206, 208 and 210, and 212 and 214. Thus, in an example embodiment, the data structure 202 may comprise a plurality of pointers where at least one of the pointers points to a data segment and at least one pointer points to a predefined reference character sequence, each pointer having an associated length that identifies either the length of the data segment or the reference character sequence as the case may be.

In the example data string 200 shown in FIG. 2, a data segment comprising characters “ABCD” (context data) is shown to be associated with a first pointer 204 and a first length 206. In particular, the first pointer 204 identifies a starting point of the data segment as shown by a row 205. In the given example, the length of the data segment is four (corresponding to characters A, B, C, and D—see arrow 207). In a similar fashion, a predefined reference character sequence (shown by way of example to be “&lt;”) is associated with a second pointer 208. In an example embodiment, the length of the second pointer may be set to zero. However, unlike the data segment, the pointer the length pair 208, 210 has a reference sequence identifier (or tokenId) 216 that identifies the particular reference character sequence in the data string 200 (which is shown to be “&lt;” in the illustrated example). The method 100 iteratively processes an input data string of any length to generate a corresponding data structure that identifies the data segments and adjacent predefined reference character sequences. For example, in the example shown in FIG. 2, a third pointer 212 which identifies the position or location of a second data segment (shown by way of example to comprise characters “EFGHI”) has a corresponding length 214 of five (see arrow 213).

Thus, merely by way of example, in FIG. 2, an example identified reference character sequence is shown to be a “&lt;” sequence in the data string 200. Thus, by processing the data string 200, the “&lt;” sequence (or any other reference character sequence) may be identified and an identifier associated with the reference character sequence may be stored in the data structure 202 (see reference sequence identifier or tokenId 216). The first pointer and length pair 204 and 206 may be used to identify the opening <TAG1> up until the start of the next data segment (e.g., in the given example the character “A”). In these circumstances, the second pointer and length pair 208 and 210 identify the data segment “ABCD” in which event no reference sequence identifier 216 would be provided. Following on this given example, the third pointer and length pair 212, 214 would then identify the example reference character sequence “&lt;” and be provided with a corresponding reference sequence identifier. Thus, the reference sequence identifier 216 would be associated with the pointer length pair 212, 214 and not the pointer length pair 208, 216.

In other words, when a predefined reference character sequence of one or more characters (or entity references) is identified in a data string, a new pointer and length entry is created in the data structure 202, which may be used to point around the identified reference character sequence. The data structure 202 may thus define a tokenized representation of the data string 200, in which the identified sequence of reference numerals may define a token.

Thus, the method 100 may process input data string 200 to generate a data structure that may subsequently be used to generate a suitable output data string for a destination device or application that may be receiving the data string. The method 100 may thus, for example, be used to convert an XML data string into multiple concurrent formats determined by the destination application by mapping the contiguous data string to element blocks aligned along substitution boundaries defined by the identified reference character sequences.

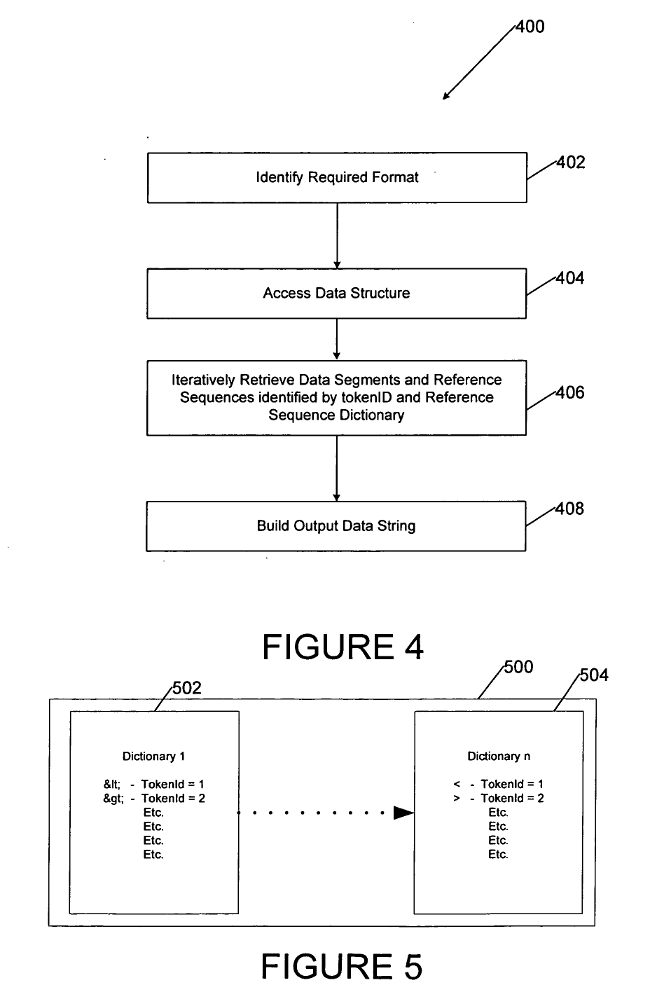

FIG. 4 shows a method 400, in accordance with an example embodiment, to provide an output data string that is suitable for (e.g., customized for) a particular destination device. As shown blocks 402, the method 400 may identify a format required by an intended destination device. In an example embodiment the format required by the destination device may be identified using a reference character dictionary 500 (see FIG. 5). For example, a first destination device may be associated with a dictionary 502, and an n^{th} destination device may be associated with an n^{th} dictionary 504. It will however be appreciated that a single dictionary may be provided that accommodates formats for multiple destination devices. When building an output data string for a particular destination device, the data structure 202 is accessed and, using the pointer and length pairs as well as the reference sequence identifiers or tokenIds a suitable output data string may be generated. As shown blocks 406, data segments and reference character sequences identified by a token ID utilizing a reference character dictionary, are iteratively retrieved in order to build and output data string (see blocks 408). As described in more detail below, the method 400 may in effect substitute appropriate reference character sequence into an output data string so that the input data string (e.g. the XML data string 200) can be converted into an appropriate data string suitable for a selected destination device, application or component.

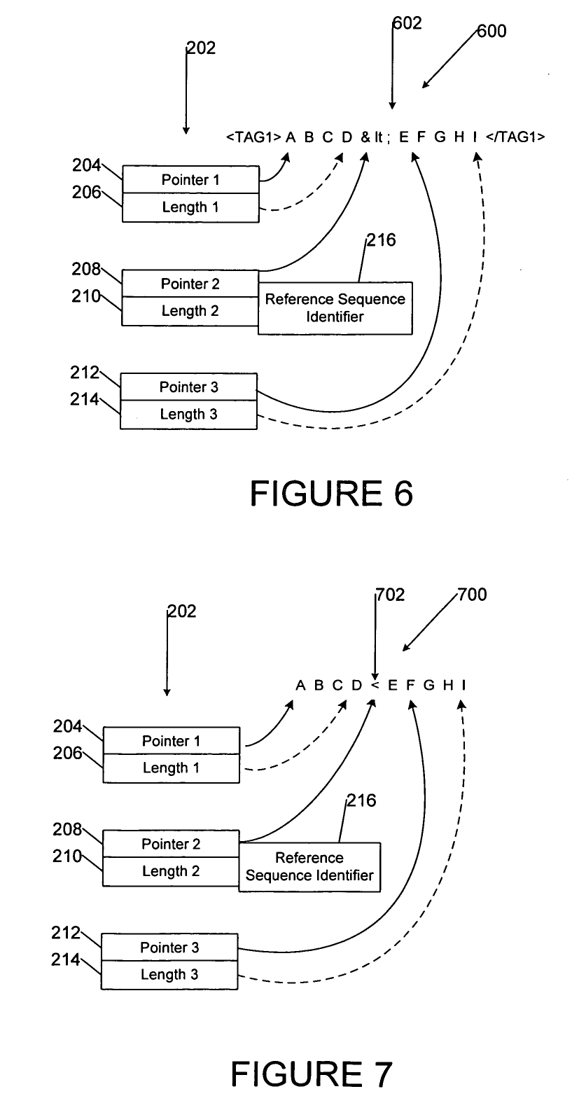

Referring in particular to FIG. 6, reference 600 generally indicates an example output data string generated from the example data structure 202 using the method 400. In the example embodiment shown in FIG. 6, an output data string 602 is shown to be in an XML format and is suitable for a destination device configured to receive data in an XML format. Thus, the output data string 602 in the given example is shown to include the reference character sequence “&lt;” and not the reference character “<” which would conflict with XML tags. However, in an example output data string 702 shown in FIG. 7, the equivalent reference character “<” is shown to be included. For example, the output data string 702 may be communicated to a destination device such as a console we data is viewed on a display. However, the output data string 602 may be communicated to a downstream network device expecting to receive XML data. When building the data output string 602, the character reference dictionary 502 is used by the method 400. However, when building the output data string 702, the character reference dictionary 504 is used by the method 400. Thus, a character reference dictionary that maps a tokenIds or reference sequence identifier to specific reference character sequence (including a sequences with a single character) depending upon the specific format requirements of a destination device.

If the format of the input string and the required format of the destination device are the same, it will be appreciated that the output data string may be on obtained directly from a buffer or memory component in which the input data string is stored. It will thus be appreciated in these circumstances the data structure 202 need not be used to generate the output data string. If, however, the format of the input data string and the format of the output data string required by the destination device are different, then the data structure 202 in conjunction with an identified reference character dictionary (as shown by way of example in FIG. 5) may be used to provide the output data string. Thus, in an example embodiment, the method 400 replaces the reference character sequences in the input data string with the retrieved substitution sequence of one or more characters to provide an output data string which is suitable for transmission to the destination or recipient device.

In an example embodiment, the data string, or part of the data string, may be encrypted. Likewise, the recipient device may or may not require data in a clear. Thus, the method 100 may comprise determining whether the data string or a part of the data string is encrypted. In this example embodiment, the method 400 may comprise identifying the destination device for the data string, and determining whether the destination device is to receive encrypted or decrypted data. If the destination device is to receive encrypted data, the method 400 may comprise using a pointer to point in the data structure 202 to encrypted data segments and transmitting an output data string to the destination device including the encrypted data segments. If, however, the destination device is to receive decrypted data or data in the clear, the method 400 may comprise using a pointer to point in the data structure 202 to decrypted data segments and generate an output data string including the decrypted data segments for communication to the destination device. Thus, merely by using different pointers in the data structure 202 either encrypted data (e.g., for transmission to another network device) or a decrypted version of the same data (e.g., for a console) may be transmitted. It is however to be appreciated that the embodiments described herein are not restricted to scenarios in which encrypted and decrypted data by required.

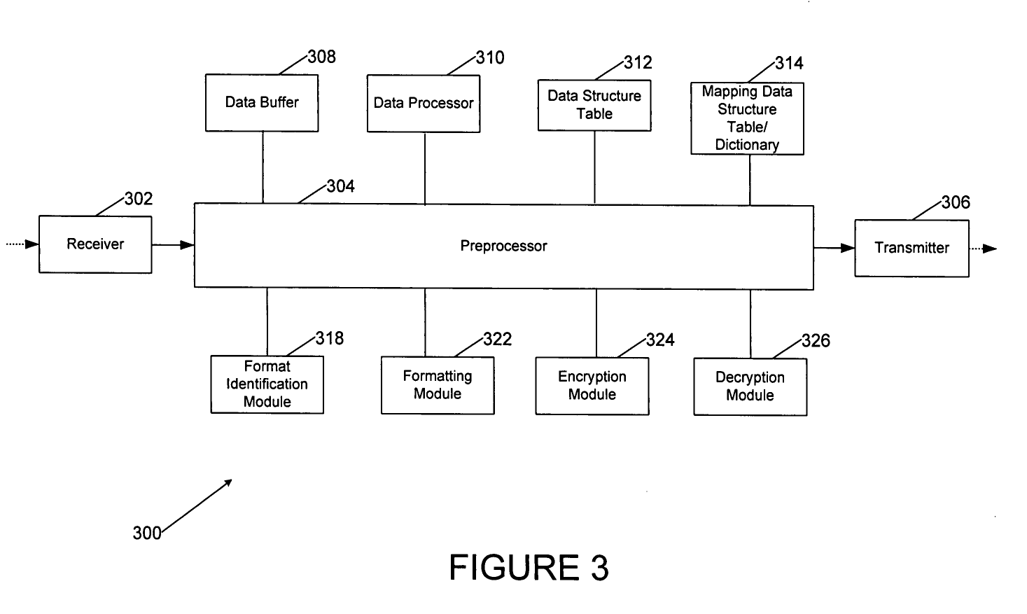

An example device 300 to implement the operations described above by way of example will now be described with reference to FIG. 3. It is however to be appreciated that deployment of the methods 100, 400 is not restricted in any way whatsoever to configuration shown in FIG. 3. The system 300 is shown to comprise a receiver 302 to receive an incoming data string, such as the data string 200, a preprocessor 304 to process the data string (e.g., at least partially execute the method 100 or the method 400), and a transmitter 306 to transmit the data string to a destination and a data or application. The system 300 may further comprise a data buffer 308 to store an input data string. Further, it is to be appreciated that the input data string may be provided in any manner in the buffer 308 and is not restricted to receiving the data string via a receiver 302.

The device 300 comprises a data processor 310 (e.g., a parser) to process the input data string to identify data segments (contexts blocks) and a predefined reference sequence of one or more characters a separate the data segments. The system 300 includes an data structure/table 312 which is populated in response to processing input data string. Once the data structure has been generated, it includes pointers to the data segments and their associated lengths, and reference sequence identifiers of one or more reference character sequences within the data string and their associated lengths (which may optionally be set to zero).

The device 300 may further comprise a mapping data structure table 314 that may comprise a mapping data structure. The mapping data structure 314 may comprise a plurality of dictionaries (see also FIG. 5) that provide a list of reference character sequences (e.g., “<”, “&lt;”, “>”, “&gt;” etc) that the data processor 310 is to search for. The mapping data structure also includes associated reference sequence identifiers or tokenIds that correspond to an associated reference character sequence. As described above, the mapping data structure table 314 may provide a substitution sequence of one or more characters in an output data string. Thus, a unique tokenId may map to the character “>” and to “&gt;”, another unique tokenId may map to the character “<” and to “&lt;” dependent upon which particular dictionary is used when building or generating the output data string. In an example embodiment, the device 300 may further comprise format identification module 318 to identify a format of the output data string.

In a further example embodiment, the device 300 may comprise an encryption detection module 324 to encrypt data and a decryption module 326 to decrypt data. The format identification module 318 may also be used to determine whether the destination device is to receive encrypted or decrypted data. As described above, pointers in the data structure may be used to include either encrypted data or data in the clear which is then communicated to another network device. It will be appreciated that such a communication need not necessarily include predetermined reference character sequences. In an example embodiment, the data may thus be stored in both an encrypted and decrypted format. Thus, merely by changing pointers, data in an appropriate format may be communicated to a destination device. For example when the data is to be communicated to a console it may be required in the clear and, accordingly, the pointers would then point to the clear data. However, when the same data is required to be communicated to a remote network device, the pointers may then point to the encrypted data. It is to be noted that multiple copies of the data structure may be provided each of which may be arranged to perform a specific substitution of reference character sequence dependent upon the destination device to which the output data string is to be sent.

In an example embodiment, the role of a dictionary (see FIG. 5) may be to provide and external to internal mapping. Using the example data string in FIG. 2 the input dictionary external token is “&lt;”. The external output token may be “<”. An internal or normalized token may thus be associated with each external token. Thus the methods and device described herein may map an external token to an internal token (or reference sequence identifier). In an example embodiment a similar mapping is available on the output side where an internal token may be mapped to external token. The internal identifier could be any value, but may be a value that will allow O(1) or constant time lookup. In an example embodiment, a single dictionary may be used for mapping of input data strings. However, multiple dictionaries may be used to generate output data strings but only one dictionary may be associated per destination device. In the given example, an external observer would see the reference character sequence “&lt;” mapped to “<” Processor Object (or State Object).

In an example embodiment, given an input string and an input dictionary, the processor may create the initial context block (e.g., the pointer/length/token id data structure shown in FIG. 2). The initial start pointer (pointer 1) may point to the beginning of the input data string and the end pointer may point to just beyond the last character of the string. The tokenId may then be initialized to 0. The processor may then parse the data string until it identifies any external tokens from the dictionary. When an external token is identified, the processor may then create two additional context blocks. Firstly, a context block may be created where a length pointer is initialized to 0 and the appropriate internal tokenId is included and, secondly, a start pointer may set the next character after the external token and the end pointer may be set to the to just beyond the last character of the string (see FIGS. 1 and 2). This methodology may continue until the input data string is consumed (or all data in a buffer is processed). At this point the Processing Object may encapsulate the state as described by the context block (thus performing a closure). At some point in the future the Processing Object may then be given an output dictionary and the inverse methodology (see FIGS. 4, 5 and 6) may be applied where the context blocks of the data structure are traversed and an output data string is created. If the message is to be delivered to multiple destinations the Processing Object may be cloned (duplicated) and then each instance may be given the appropriate dictionary for its destination device. In an example embodiment, the methodology described herein is reversible m==>f(m, d)==>f′(m′, d′)==>m.

The embodiments described herein may also be used to convert BNF grammar text strings into other formats. In particular, a translation service application may be provided comprising a database of scripts (e.g., awk, sed) to convert BNF text strings into any desired format. Thus, instead of the data structure simply providing a substitution sequence, a script may be executed in order to generate the required translation or formatting of the data string. The data structure may, for example, use three keys to return a script capable of converting the input data string. The keys may comprise an IOS version, an application identification, and an operation name. The returned value may be a script to verify and convert the BNF input data string.

In one application, the methods and systems described above may be used in network management whenever a user needs to interpret the output of an IOS command. The user may define a required conversion in the element data structure table. In addition, the methods and systems described herein may allow an IOS device to do its own translation, which means that the conversion may be stateless.

In an example embodiment, the methods and systems described herein may provide an improvement for data string transfer in terms of performance and memory utilization. This may be achieved by reusing the data structure, instead of making copies of the data string in the data buffer so as to minimize data copies. In addition, the data structure may improve the performance of XML forwarding.

In an example embodiment, the methods and systems described above may be optimized by including them in the code building the data string, so that the data string can go directly into a tokenized representation of the data string. The element of the data structure may be a constant that is widely accessible to components and applications within the network.

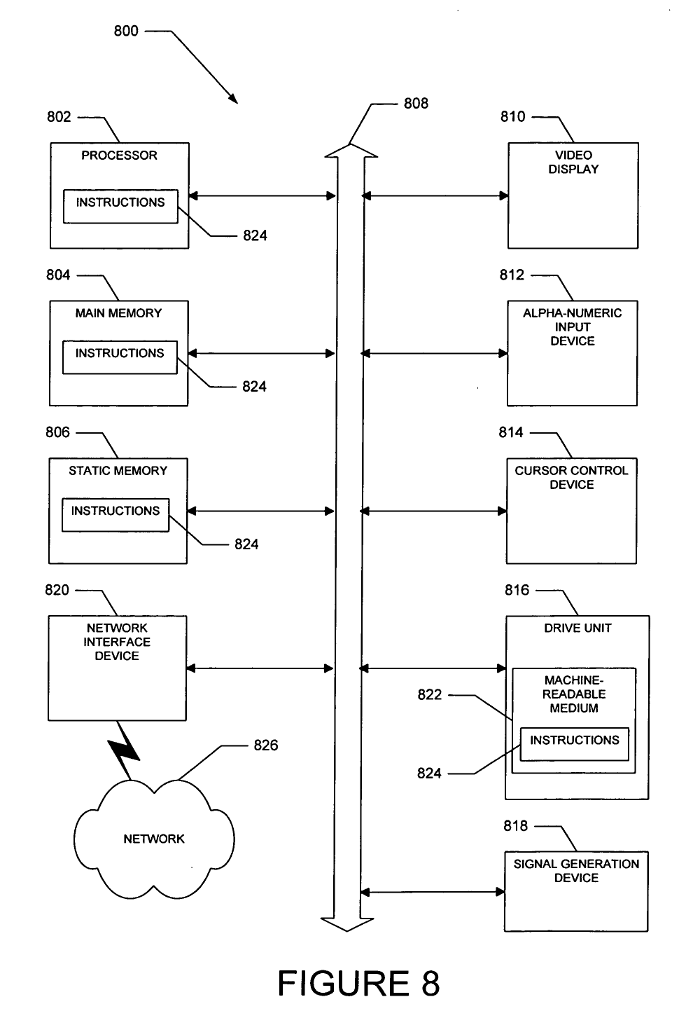

FIG. 8 shows a diagrammatic representation of machine in the example form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although the present application has been described with reference to specific example embodiments, it will be evident that various modifications and changes may be made to these embodiments without departing from the broader spirit and scope of the application. Accordingly, the specification and drawings are to be regarded in an illustrative rather than a restrictive sense.

1. A computer-readable medium embodying instructions to process a data string, the instructions when executed by a machine cause the machine to:
access the data string to identify
a plurality of data segments; and
a plurality of predefined reference character sequences, wherein each predefined reference character sequence is located between adjacent data segments; and
create a data structure to identify
a location and length of each data segment within the data string; and
a location of each predefined reference character sequences within the data string.

2. The computer-readable medium of claim 1, which causes the machine to:
access at least one reference character dictionary to obtain predefined reference character sequences to be identified in the data string.

3. The computer-readable medium of claim 2, which causes the machine to store a plurality of reference character sequence identifiers in the data structure, each reference character sequence identifier identifying an associated reference character sequence.

4. The computer-readable medium of claim 3, wherein a reference character sequence identifier common to a plurality of different dictionaries corresponds to a different reference character sequence in each different reference character dictionary.

5. The computer-readable medium of claim 1, in which accessing the data string comprises:
parsing the data string to identify the plurality of data segments and the plurality of references character sequences; and
storing the data structure in a network device.

6. The computer-readable medium of claim 1, which causes the machine to generate a plurality of pointer and length pairs, each pointer and length pair identifying a location where a data segment begins in the data string, or a location where a predefined reference character sequence begins in the data string.

7. The computer-readable medium of claim 6, in which a subsequent pointer that follows a previous pointer in the data structure corresponds to the position of the previous pointer added to a length of an adjacent predefined reference sequence.

8. The computer-readable medium of claim 1, wherein the data string is an XML data string.

9. A device to process a data string, the device comprising:
a processor to identify
a plurality of data segments; and
a plurality of predefined reference character sequences, wherein each predefined reference character sequence is located between adjacent data segments; and
memory to store a data structure to identify
a location and length of each data segment within the data string; and
a location of each predefined reference character sequences within the data string.

10. The device of claim 9, wherein the processor is configured to access at least one reference character dictionary to obtain predefined reference character sequences to be identified in the data string.

11. The device of claim 10, in which the processor is configured to store a plurality of reference character sequence identifiers in the data structure, each reference character sequence identifier being to identify an associated reference character sequence.

12. The device of claim 11, wherein a reference character sequence identifier common to a plurality of different dictionaries corresponds to a different reference character sequence in each different reference character dictionary.

13. The device of claim 9, in which the processor is configured to generate a plurality of pointer and length pairs, each pointer and length pair being to identify a location where a data segment begins in the data string, or a location where a predefined reference character sequence begins in the data string.

14. The device of claim 13, in which a subsequent pointer that follows a previous pointer in the data structure corresponds to the position of the previous pointer added to a length of an adjacent predefined reference sequence.

15. The device of claim 9, in which the device is a network device configured to process packets in a data communications network.

16. A computer-readable medium embodying instructions to process a data string, the instructions when executed by a machine cause the machine to:
access a data structure to identify
a sequence of data segments; and
a plurality of predefined reference character sequences; and
combine the data segments and the predefined reference character sequences based on the data structure to provide the output data string.

17. The computer-readable medium of claim 16, which causes the machine to:
access at least one reference character dictionary to obtain predefined reference character sequences to be included in the output data string.

18. The computer-readable medium of claim 16, which causes the machine to retrieve a plurality of reference character sequence identifiers from the data structure, each reference character sequence identifier identifying an associated reference character sequence.

19. The computer-readable medium of claim 18, wherein a reference character sequence identifier common to a plurality of different dictionaries corresponds to a different reference character sequence in each different reference character dictionary.

20. The computer-readable medium of claim 19, wherein the data structure comprises a plurality of pointer and length pairs and in which accessing the data structure comprises utilizing the pointer and length pairs to identify the data segments and predefined reference character sequences.

21. The computer-readable medium of claim 16, which causes the machine to identify a plurality of data segments and a plurality of predefined reference character sequences, and in which the combining includes locating an associated reference sequence between adjacent data segments.

22. The computer-readable medium of claim 21, in which a subsequent pointer that follows a previous pointer in the data structure corresponds to the position of the first pointer added to an associated length of the predefined reference sequence.

23. The computer-readable medium of claim 16, which causes the machine to use a plurality of pointer and length pairs to access the data segments, each pointer identifying a location in a data buffer where storage of an associated data segment begins or identifying where an identifier to identify the identified reference sequence of one or more characters begins.

24. The computer-readable medium of claim 16, in which the data structure comprises a plurality of pointers, the instructions causing the machine to:
combine encrypted data in the output data string when a pointer of the plurality of pointer points to an encrypted segment of data; and
combine decrypted data in the output data string when a pointer of the plurality of pointers that points to a decrypted segment of the same data.

25. A device to provide an output data string for transmission to a destination device, the device comprising:
memory to store a data structure; and
a processor to access the data structure to identify
a sequence of data segments; and
a plurality of predefined reference character sequences; and
wherein the data segments and the predefined reference character sequences are combined to provide the output data string based on the data structure.

26. The device of claim 25, which comprises at least one reference character dictionary which is accessed to obtain predefined reference character sequences to be included in the output data string.

27. The device of claim 25, wherein the processor is configured to retrieve a plurality of reference character sequence identifiers from the data structure, each reference character sequence identifier identifying an associated reference character sequence.

28. The device of claim 27, wherein a reference character sequence identifier common to a plurality of different dictionaries corresponds to a different reference character sequence in each different reference character dictionary.

29. A method to process a data string, the method comprising:
accessing the data string to identify
a plurality of data segments; and
a plurality of predefined reference character sequences, wherein each predefined reference character sequence is located between adjacent data segments; and
creating a data structure to identify
a location and length of each data segment within the data string; and
a location of each predefined reference character sequences within the data string.

30. A method to provide an output data string for transmission to a destination device, the method comprising:
accessing a data structure to identify
a sequence of data segments; and
a plurality of predefined reference character sequences; and
combining the data segments and the predefined reference character sequences based on the data structure to provide the output data string

31. A device to process a data string, the device comprising:
means for accessing the data string to identify
a plurality of data segments; and
a plurality of predefined reference character sequences, wherein each predefined reference character sequence is located between adjacent data segments; and
means for creating a data structure to identify
a location and length of each data segment within the data string; and
a location of each predefined reference character sequences within the data string.

32. A device to provide an output data string for transmission to a destination device, the device comprising:
means for accessing a data structure to identify
a sequence of data segments; and
a plurality of predefined reference character sequences; and
means for combining the data segments and the predefined reference character sequences based on the data structure to provide the output data string.
